(19) United States
(12) Patent Application Publication
(10) Pub. No.: US 2004/0203350 A1
(43) Pub. Date: Oct. 14, 2004

(54) Wireless communication device and method for information retrieval using a universal identity metatag

(75) Inventors: Travis T. Shultz, Hillsboro, OR (US); Rajesh P. Banginwar, Hillsboro, OR (US); Marion H. Shimoda, Aloha, OR (US); Thomas M. Cronin, Hillsboro, OR (US); Roger A. Hurwitz, Portland, OR (US)

Correspondence Address: SCHWEGMAN, LUNDBERG, WOESSNER & KLUTH, P.A., P.O. BOX 2938, MINNEAPOLIS, MN, 55402, US

(73) Assignee: Intel Corporation

(21) Appl. No.: 10/140,515

(22) Filed: May 7, 2002

(51) Int. Cl. H04B 5/00; H04B 1/38

(52) U.S. Cl. 455/41.1; 455/415; 455/556.1

(57) ABSTRACT

A wireless communication device (WCD) tags records, such as documents or graphic files, with universal identity metatags (UIMs). The UIMs may associate many disconnected pieces of information. A WCD may automatically extract information from a record to generate a UIM or may extract information from in-proximity WCDs that are identified during a discovery process. A WCD may extract information from a calendar application to generate a UIM. A WCD may also retrieve a record related to an upcoming meeting, for example, from a separate device, such as the user's computer, based on information from a calendar application. A WCD may also use the UIM to identify and retrieve related records on in-proximity WCDs as well as provide records to an in-proximity WCD requesting a record.

### TECHNICAL FIELD

The present invention pertains to electronic communications, and in particular, to relating information accessible by wireless communication devices.

### BACKGROUND

Conventional methods of relating information include the use of metadata and metadata in documents such as Hypertext Markup Language (HTML) documents. Metadata is data about data and metatags conventionally define the metadata. Examples of conventional metatags that identify metadata include “author,” “language,” and “character set.” For example, the Internet is made up of numerous Web sites that maintain and distribute Web documents. A Web site may use one or more Web servers to store and distribute documents in one of a number of formats including HTML. HTML documents include metatags and metadata that contain embedded “links” or “hyperlinks” that reference other data or documents located on the same or another Web server. The HTML documents and the document referenced in the hyperlinks may include text, graphics, audio, or video in various formats referenced by the metatags. Web crawlers and search engines have been conventionally employed to search metadata and metatags in HTML documents.

These conventional methods of relating information, however, are not very helpful for business professionals who often require information for a particular task that is not collected or associated together. This information may be located on personal computers and/or wireless devices, which may or may not be controlled by the person requiring the information. Often, the information may be comprised of disconnected pieces that pertain to a particular person or task. Finding the appropriate information in a timely manner can be a time-consuming and error prone process. This problem is particularly troublesome for the mobile professional who may need access to information from remote locations.

### BRIEF DESCRIPTION OF THE DRAWINGS

The appended claims point out different embodiments of the invention with particularity. However, the detailed description presents a more complete understanding of the present invention when considered in connection with the Figures, wherein like reference numbers refer to similar items throughout the Figures and:

FIG. 1 illustrates the operational environment of universal identity metatags in accordance with an embodiment of the present invention;

FIG. 2 is a functional block diagram of a mobile communication device in accordance with an embodiment of the present invention;

FIG. 3 is an example of a universal identity metatag in accordance with an embodiment of the present invention;

FIG. 4 is a flow chart of a procedure for creating a universal identity metatag in accordance with an embodiment of the present invention; and

FIG. 5 is a flow chart of a procedure for retrieving records using universal identity metatags in accordance with an embodiment of the present invention.

### DETAILED DESCRIPTION

The following description and the drawings illustrate specific embodiments of the invention sufficiently to enable those skilled in the art to practice it. Other embodiments may incorporate structural, logical, electrical, process, and other changes. Examples merely typify possible variations. Individual components and functions are optional unless explicitly required, and the sequence of operations may vary. Portions and features of some embodiments may be included in or substituted for those of others. The scope of the invention encompasses the full ambit of the claims and all available equivalents.

The present invention pertains to electronic communications, and in particular to wireless communications. In accordance with one embodiment, the present invention relates disconnected pieces of information to facilitate sharing such related information among in-proximity wireless devices.

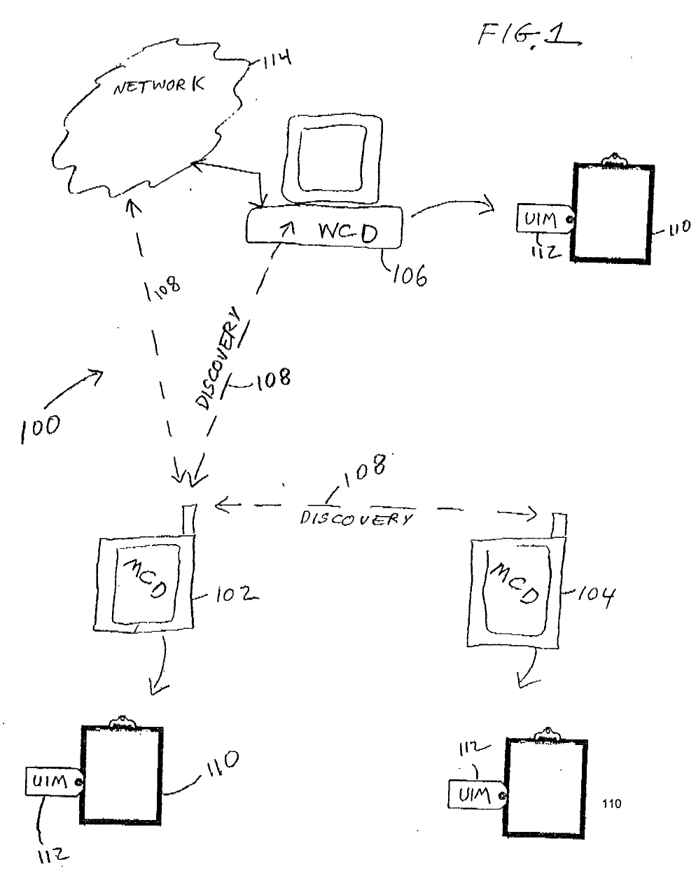

FIG. 1 illustrates the operational environment of universal identity metatags in accordance with an embodiment of the present invention. Operational environment 100 may include wireless communication devices (WCDs) 102, 104 and 106 that may discover each other through a discovery process and communicate therebetween over wireless links 108. The WCDs include stationary wireless communication devices such as device 106 which may be a computer or computer terminal with wireless communication capability. The WCDs may also include portable and mobile communication devices (MCDs), such as devices 102 and 104, which may be configured to operate at almost any location. In general, the WCDs may include, for example, personal digital assistants (PDAs), laptop and portable commuters with wireless communication capability, web tablets, wireless telephones, pagers, instant messaging devices, MP3 players, digital cameras, and other devices that may receive and/or transmit information wirelessly. The WCDs may communicate with network 114 which may be the Internet, an intranet, or other network.

Links 108 may be any wireless or wireline communication path, and in one embodiment, parameters for communication over a link may be established during a discovery process between two WCDs. Links 108 may include a wireless local area network (WLAN) link or a personal area network (PAN) link. Examples of links 108 include a wireless communication link in accordance with a Bluetooth protocol, an infrared data link in accordance with the Infrared Data Association (IrDA) protocol, a wireless communication link in accordance the IEEE 802.11a protocol, the IEEE 802.11b protocol, or the IEEE 802.11g protocol, and a wireless communication link in accordance with a home-RF protocol such as the Home-RF Working Group (HRFWG) standard. WCDs may include hardware and software interfaces to provide communication capability over one or more of these links with other WCDs. In one embodiment, communication links 108 may be short distance links (e.g., less than 100 feet) and may provide substantially line-of-site communications. In this embodiment, WCDs may be in-proximity to each other for establishment of a communication link. In one embodiment, WCDs may communicate with other devices utilizing peer-to-peer communications.

The WCDs may generate and store records 110, and may also tag records 110 with universal identity metatags (UIMs) 112. A WCD may use UIMs 112 to retrieve tagged records 110 from information storage within itself as well as retrieve tagged records 110 stored within or accessible through other WCDs. Records 110 include any item of information that may be stored in a digital form. For example, records 110 may include documents, spreadsheets, graphics files, pictures, audio/visual information, messages, and multimedia information.

In one embodiment of the present invention, meeting records may be tagged with UIMs 112. For example, a record of the meeting between business professionals may be generated on a WCD present at the meeting. The record may be a document generated by a word processing application, or may be generated from conversations from the meeting that are converted to text by a speech recognition application running on the WCD. WCD 102 may extract information from the record to generate a UIM. The UIM may be stored by itself or may be embedded in the record. In one embodiment, WCD 102 may discover one or more in-proximity WCDs, such as WCD 104, present at the meeting by an ad-hoc discovery process and may include the identities of the in-proximity WCDs in the UIM that tags the meeting record. In one embodiment, WCD 102 may retrieve pertinent or related records from in-proximity WCD 104. The pertinent or related record may be similarly tagged linking related information together. The record generated during the meeting may be shared with in-proximity WCDs that may use the UIM to identify the record and related items.

In another embodiment of the present invention, caller identifiers may be used to identify records. In this embodiment, when the WCD includes functionality of, for example, a wireless telephone, the WCD may determine a calling party's identity (e.g., by a caller ID method) and may automatically identify and retrieve records related to the calling party by searching the UIMs stored on the WCD. The WCD may also identify related records on an in-proximity WCD, such as the user's computer, and may retrieve such records. The related records may be readily available for the user during the telephone call.

In yet another embodiment, a network identifier may be used to identify records tagged with UIMs. A network identifier may include an IP address, email address, or other identifier that may be used to identify a device through network connections. In this embodiment, a WCD may automatically identify and retrieve records related to a party or device in network communication with the WCD. For example, when a WCD receives a network communication such as an email or an instant message from a networked device, a network identifier may be used by the WCD to identify records using UIMs identified with the network identifier.

In yet another embodiment, a WCD (such as a PDA) may retrieve records from a user's personal computer that may be pertinent to an upcoming meeting prior to the meeting. For example, WCD 102 may query a calendar application operating on WCD 102 to identify the upcoming meeting. WCD 102 may extract information from the calendar application, such as location, persons attending, topic, and project name. WCD 102 may use this information to request records on WCD 106. In this embodiment, WCD 106 may search UIMs to identify records and may transmit these records to WCD 102. This process may be performed automatically by WCD 102 depending on, for example, conditions set within a policy manager. Accordingly, a user may have automatic and easy access to relevant records at meetings. In this embodiment, the requested records may be transferred over wireless link 108. Alternatively, the requested records may be transferred over a wired link that may be established when WCD 102 is coupled with WCD 106 (e.g., when a user places a PDA in a cradle coupled with a computer). In this alternative embodiment, there may be no requirement for WCD 106 to have wireless communications capability.

In yet another embodiment, a WCD may transmit a record to an in-proximity WCD requesting a record. In this embodiment, WCD 104, for example, may request a record on or accessible by WCD 102. The request may include one or more UIMs or may include fields of UIMs. WCD 102 may authenticate WCD 104 in accordance with a policy manager or an access control list prior to sending the record to WCD 104. The parameters for communicating over link 108 may be determined during a discovery process. In this embodiment, WCDs may automatically identify, request and receive records from in-proximity wireless devices.

The use of UIMs 112 may relate records that may not necessarily reside with the device, person or document that contains the UIM. In one embodiment, UIMs 112 may be universal allowing easy transportability across a range of devices and communication methods. UIMs 112 may enable real-time and time-sensitive retrieval of formerly disassociated or disconnected records. UIMs 112 may be associated with persons, documents, services or multimedia information.

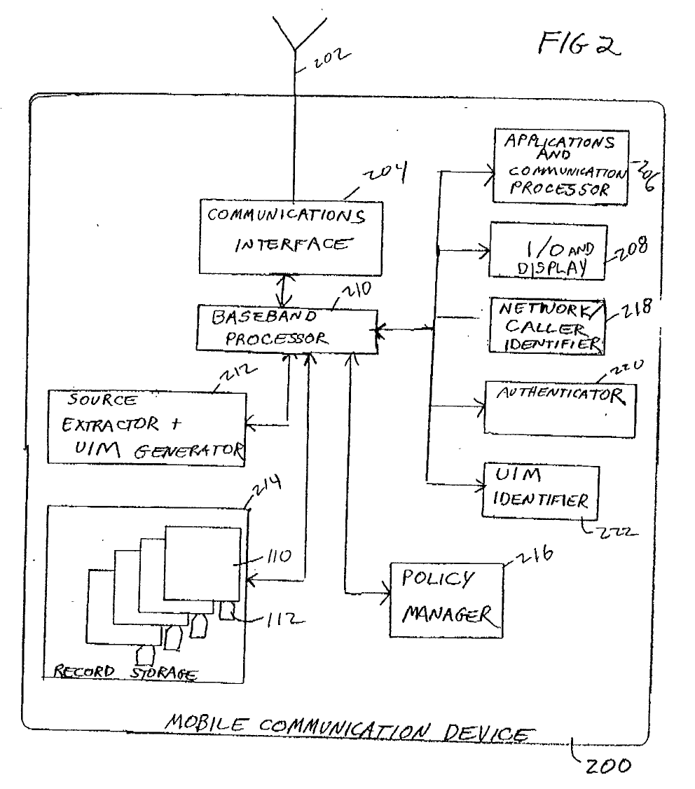

FIG. 2 is a functional block diagram of a mobile communication device in accordance with an embodiment of the present invention. Mobile communication device (MCD) 200 may be suitable for any of communication devices 102 and 104 (FIG. 1) although other devices are also suitable. For example, WCD 106 (FIG. 1) may include the functional elements of MCD 200. MCD 200 may include antenna 202 for receiving and transmitting signals over wireless communication channels, utilized by links 108 (FIG. 1). MCD 200 may also include communications interface 204 to communicate with one or more communication networks (e.g., cellular telephone or wireless communication networks) and/or other communication devices as described herein. Mobile device 200 also includes baseband processor 210 to receive baseband signals from interface 204 and provide baseband signals to interface 204. Mobile device 200 also includes communications processor 206 for implementing one or more communications applications depending on the functionality of mobile device 200. For example, device 200 may include, among other things, PDA applications, instant messaging applications, and/or wireless phone applications. Device 200 may also have an I/O and display 208 for receiving user inputs and presenting information to the user. The combination of communication interface 204, baseband processor 210, applications and communications processor 206 and display 208 permit device 200 to operate as a mobile communication device which may be, for example, a PDA, a laptop and portable commuter, a web tablet, a wireless telephone, a pager, an instant messaging device, an MP3 player, a digital camera or a general purpose processing device.

Device 200 may also include source extractor and UIM generator 212 to extract source information from records 110 and generate one or more UIMs 112 for associating with a person, document, service or information, and/or embedding the UIM in a record. UIMs and/or records 110 with embedded UIMs 112 may be stored in record storage element 214, which may be a memory, hard drive, CDROM of other storage element. Device 200 may also include policy manager 216 to operate in accordance with policies and procedures relating, for example, to the generation of UIMs 112, to retrieving records tagged with UIMs 112 and to transmitting records tagged with UIMs. The policies and procedures implemented by policy manager 216 may be set by a user and may be implemented automatically without user intervention. This may allow the automatic tagging of records with UIMs 112 as well as the automatic requesting and receipt of records tagged with UIMs 112. In one embodiment, policy manager 216 may permit the automatic authorization and transmission of records tagged with UIMs 112 to other devices.

Device 200 may include identifier 218 which may identify a device or party calling or in network communication with device 200. Identifier 218 may also provide the identification information to UIM generator 212 for use in generating a UIM for a record that may relate to the device or party. Device 200 may also include authenticator 220 to authenticate users and/or other WCDs prior to transmission of a tagged record that may have been requested by the other device. Device 200 may also include UIM identifier 222 which may generate information used to identify UIMs 112 for retrieving a tagged record. Although device 200 is illustrated in FIG. 2 as having many separate functional elements, any one or more of these functional elements may be combined and implemented in hardware and/or with one or more processing elements configured with firmware and/or software.

Communication interface 204 may be comprised of transceivers for providing communications in accordance with one or more various communication formats including hardware and/or physical connectivity protocols that may include wireless local area network (WLAN) protocols and/or wireless personal area network (WPAN) protocols. For example, interface 204 may include a Bluetooth transceiver to provide digital communications in accordance with a Bluetooth protocol. Interface 204 may include, for example, transceivers to respectively provide digital communications in accordance the IEEE 802.11a protocol, the IEEE 802.11b protocol, and/or the IEEE 802.11g protocol. Interface 204 may include, for example, an infrared transceiver to support an infrared serial data link, which for example, may be in accordance with the Infrared Data Association (IrDA) protocol. Interface 204 may include, for example, a home-RF transceiver to provide a digital communication link in accordance with a Home-RF protocol. Interface 204 may include, for example, other wireless transceivers for providing wireless communications in accordance with other physical connectivity protocols and/or standards. In one embodiment, a connectivity protocol, such as universal plug and play (UPnP), may run on top of the physical connectivity protocols discussed above.

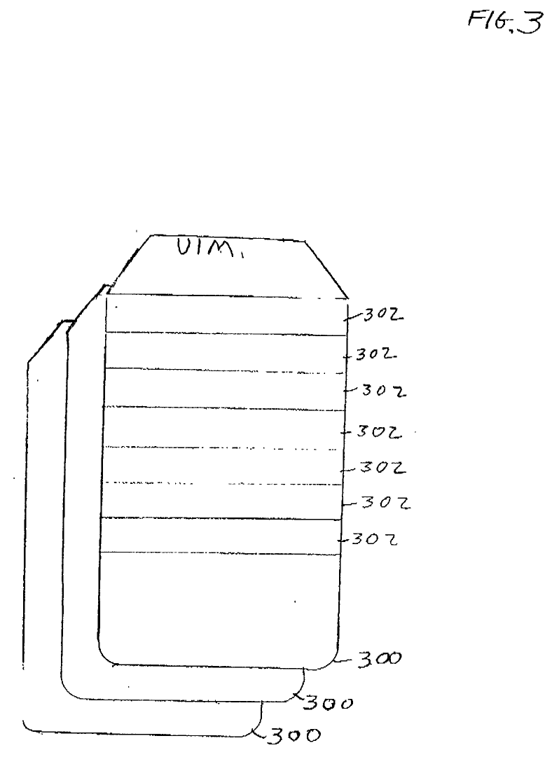

FIG. 3 is an example of a universal identity metatag (UIM) in accordance with an embodiment of the present invention. UIM 300 may be suitable for use as UIM 112 (FIG. 1) although other tags may also be suitable. UIM 300 may be embedded in record 110, and in one embodiment, may be an embedded object in record 110. Alternatively, UIM 300 may be a stand-alone object. In one embodiment, a record may have more than one UIM 300 associated therewith. UIM 300 includes one or more fields 302 that may be used to identify one or more records, persons, entities or services. Examples of fields 302 that pertain to a record include record category, record type (e.g., picture or document), title, project number or description, key words or phrases, creation date, access control list (e.g., for authenticated recipients), etc. When a record is created during a meeting, for example, or when the record results from a meeting, fields 302 may also identify persons, entities or devices involved in creating the record and/or attending the meeting. Fields 302 may be extracted from information in a record during or after the creation of the record. Fields 302 may also be extracted from a calendar application or from other devices present at a meeting. Source extractor and UIM generator 212 (FIG. 2), for example, may perform these operations. At a minimum, a UIM may have at least one field relating the associated information. This at least one field is not necessarily the same one or more fields for all UIMs. For example, in one embodiment, UIMs may have separate fields relating to people, places, concepts or things, and the UIMs may be associated with at least one of those field's contents, but not necessarily a particular field.

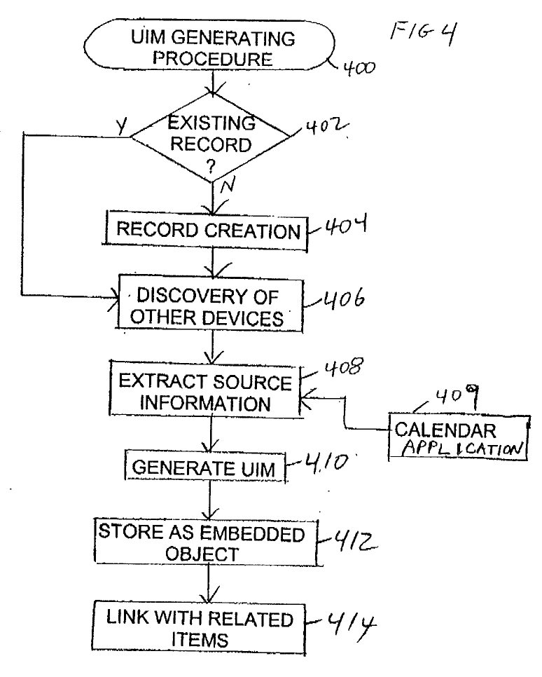

FIG. 4 is a flow chart of a procedure for creating a universal identity metatag (UIM) in accordance with an embodiment of the present invention. Procedure 400 may be performed by a WCD such as WCD 102, 104 or 106 (FIG. 1) to generate a UIM such as UIM 300 (FIG. 3). Although the individual operations of procedure 400 are illustrated and described as separate operations, one or more of the individual operations may be performed concurrently and nothing requires that the operations be performed in the order illustrated. Procedure 400 may be performed on a continuous basis to generate UIMs and/or to tag records with UIMs. Procedure 400 may be performed for existing records and newly created records, as well as for records that are received from a source external to the WCD performing procedure 400.

Operation 402 determines if procedure 400 will generate a UIM for an existing record. When a record does not exist, operation 404 creates the record. Operation 404 may include generating a record with a word processing application to generate a document, generating a record that's comprised of an audio or video file, generating a graphics file with a graphics application, etc. For example, operation 404 may generate a record of meeting minutes. The meeting minute record may be generated, for example, with a word processing application or a speech recognition application operating on the WCD. The record may also be generated from graphics presented during a meeting (e.g., from view cells or pictures). Operation 404 may, for example, be performed by applications and communications processor 206 of WCD 200 (FIG. 2).

Operation 406 discovers in-proximity WCDs. In one embodiment, these in-proximity WCDs may be present, for example, at a meeting during which operation 404 creates a record. In this embodiment, the WCD performing operation 406 may receive information from one or more in-proximity WCDs discovered in operation 406 for use in generating the record in operation 404. In this embodiment, operation 404 and 406 may be performed concurrently. In another embodiment, when procedure 400 generates a UIM for an existing record, information about the in-proximity WCDs discovered in operation 406 may be used in generating a UIM in operation 410 described below.

Operation 406 may include performing a discovery process, such as an ad-hoc type discovery process to determine communication parameters for identifying and communicating with the in-proximity wireless communication devices. For example, operation 406 may determine parameters for communicating over a wireless communication link in accordance with a Bluetooth protocol, an infrared data link in accordance with the Infrared Data Association (IrDA) protocol, a wireless communication link in accordance an IEEE 802.11 protocol, or a wireless communication link in accordance with a home-RF protocol. Operation 406 may, for example, be performed by communications interface 204 of WCD 200 (FIG. 2).

Operation 408 extracts information from a record to generate a UIM for the record. The record may be an existing record or may have been generated in operation 404. The information that may be extracted from the record may correspond with the fields of a UIM, such as fields 302 (FIG. 3). In one embodiment, calendar application 409 may be queried to determine information pertinent to the record for generating the UIM in operation 408. For example, when the record is associated with or generated from or during a meeting, operation 408 may extract, for example, the meeting topic, meeting time and location, and parties attending the meeting from calendar application 409. Calendar application 409 may be operating on the WCD performing procedure 400, or in another embodiment, may be operating on an in-proximity WCD discovered in operation 406. In one embodiment, an existing record may already have an UIM associated with it. In this embodiment, operation 408 may extract information from the existing UIM.

Operation 410 generates the UIM for the record from the information extracted in operation 408. The UIM may also include identities of in-proximity WCDs discovered in operation 406. Portions of the UIM may be determined in accordance with a policy manager operating on the WCD performing procedure 400. For example, the policy manager may set access and security requirements of the record which may be defined in the fields of the UIM. In one embodiment of the present invention, several UIMs may be generated for a record. In this embodiment, each UIM may be associated with a single concept, such as a person, place, meeting, or thing. Some implementations may benefit from the use of multiple UIMs, for example, when searching over a low-bandwidth network. In another embodiment, an existing record may already have one or more UIMs associated with it. In this embodiment, operation 410 may generate an additional one or more UIMs for that record. Operations 408 and 410 may, for example, be performed by source extractor and UIM generator 212 of WCD 200 (FIG. 2).

Operation 412 stores the UIM generated in operation 410 so that it is easily associated with, for example, a record, device or person. In one embodiment, the UIM is embedded as an object within the record. The record may be stored on the WCD performing procedure 400. In one embodiment, when the record is generated, for example, during a meeting, the record with the associated UIM may be transmitted to one or more of the in-proximity WCDs discovered in operation 406 that may be attending the meeting. The UIMs generated in operation 412 may, for example, be stored in record storage 214 of WCD 200 (FIG. 2), either separately or associated with a record.

Operation 414 links the record with related items using the associated UIM. Operation 414 may identify related records on the WCD performing procedure 400 and may include identities of these related records in the UIM generated in operation 410. In one embodiment, operation 414 may identify related records on in-proximity WCDs discovered in operation 406, and may include identities of these related records in the UIM generated in operation 410. These related records may be requested and/or received as part of operation 414. Operation 414 may be performed concurrently or in conjunction with operations 410 and 412.

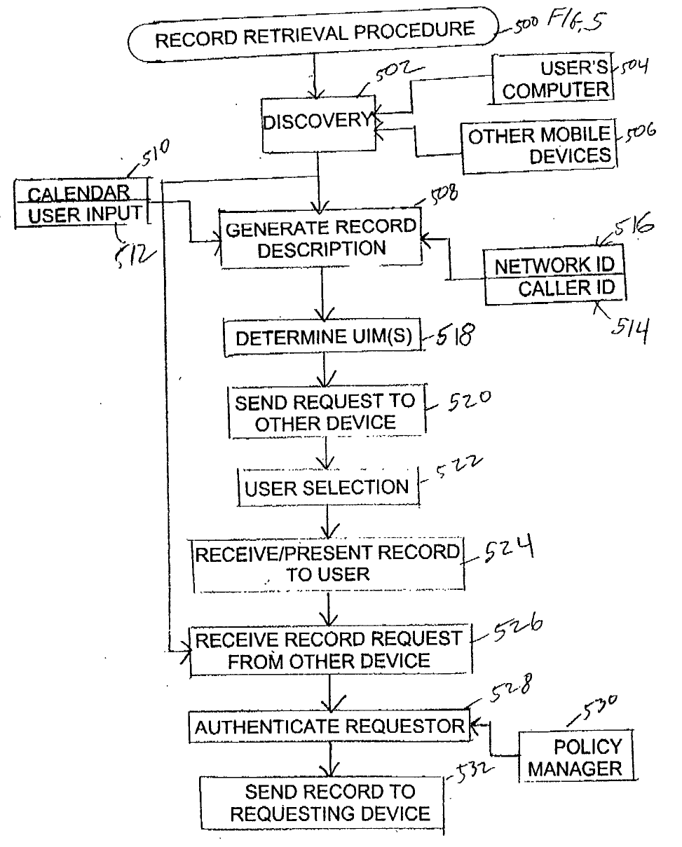

FIG. 5 is a flow chart of a procedure for retrieving records using universal identity metatags in accordance with an embodiment of the present invention. Procedure 500 may be performed by a WCD such as WCD 102, 104 or 106 (FIG. 1) to retrieve information, such as record 110 (FIG. 1). Records may be retrieved from other WCDs including discovered in-proximity WCDs as well as from storage on a user's WCD. Records may also be retrieved from networks assessable through a WCD. In one embodiment, a record may be requested from a WCD. Although the individual operations of procedure 500 are illustrated and described as separate operations, one or more of the individual operations may be performed concurrently and nothing requires that the operations be performed in the order illustrated.

Operation 502 discovers in-proximity WCDs. Operation 502 may include performing a discovery process, such as an ad-hoc type discovery process to determine communication parameters for identifying and communicating with in-proximity wireless communication devices. For example, parameters for communicating over a wireless communication link in accordance with a Bluetooth protocol, an infrared data link, a wireless communication link in accordance an IEEE 802.11 protocol, or a wireless communication link in accordance with a home-RF protocol may be determined. In-proximity WCDs discovered in operation 502 may include, for example, user's computer 504, such as WCD 106 (FIG. 1), as well as other mobile communication devices 506 such as MCD 104 (FIG. 1). Operation 502 may be performed, for example, by communication interface 204 of WCD 200 (FIG. 2).

Operation 508 generates one or more record descriptors. The record descriptors may be used to determine portions of UIMs for use in retrieving a record. In one embodiment, operation 508 may generate a record description from a calendar application 510. Calendar application 510 may be operating on the WCD, such as a PDA, performing procedure 500, or calendar application 520 may be operating on an in-proximity WCD such as the user's computer. In this embodiment, the calendar application may be automatically queried to identify an upcoming meeting and information may be extracted about the meeting to generate one or more record descriptors. In another embodiment, user input 512 may be used to generate a record descriptor. In this embodiment, a user may provide information for use in retrieving a record with a UIM.

In yet another embodiment, operation 508 may use caller identity (ID) 514 to generate a record descriptor. In this embodiment, the WCD performing procedure 500 may receive an incoming call and may identify the incoming caller using a caller ID technique. The caller identity information may be used in retrieving a record with a UIM that lists the calling party. In yet another embodiment, operation 508 may use network ID 516 to identify a party sending a message over a network connection. The network ID information may be similarly used in retrieving a record in the operations described below.

Operation 518 determines UIMs from the record descriptor generated in operation 508. In one embodiment, operation 518 generates portions of UIMs, such as one or more fields 302 (FIG. 3). The UIMs, (or portions thereof) may be used to identify records stored on a WCD or accessible through a WCD.

In one embodiment, operation 520 is performed. In operation 520, a record request is sent to one or more in-proximity WCDs discovered in operation 502. The record request may include the UIM or portion thereof determined in operation 518.

Operation 522 may list records identified by their UIM to a user and may wait for the user to select which records are desired. The listed records may be present on in-proximity WCDs as well as on the user's WCD. In one embodiment, operation 522 may automatically select all records or select records in accordance with criteria set by a policy manager application operating on the user's WCD. Operation 524 receives the requested records and may present them to the user. In one embodiment, when a record is identified on an in-proximity WCD, the in-proximity WCD may authenticate the recipient as authorized to receive the requested record.

In one embodiment of the present invention, operations 502, 508 and 518 through 524 may be performed substantially automatically allowing a user's WCD to retrieve pertinent records and make those records available to the user in a timely manner, for example, for an upcoming meeting or in response to a calling party. In another embodiment, operations 526, 528 and 532 facilitate a WCD to provide requested records to other WCDs. Operation 526 receives a request from an in-proximity WCD for a record. The request identifies a UIM or one or more portions of a UIM. Operation 528 authenticates the requesting WCD and may identify any records matching the request. Operation 528 may identify records having UIMs with fields matching the request. Operation 528 may utilize policy manager 530 to determine whether or not the user has indicated if a particular record may be transferred or if the requesting party is authorized to receive the record. Policy manager 530, in one embodiment, may prompt the user to indicate whether or not the requested record should be transferred. In operation 532, the requested record is transmitted to the requesting WCD over a link. The link's parameters may have been determined during discovery operation 502.

The foregoing description of specific embodiments reveals the general nature of the invention sufficiently that others can, by applying current knowledge, readily modify and/or adapt it for various applications without departing from the generic concept. Therefore such adaptations and modifications are within the meaning and range of equivalents of the disclosed embodiments. The phraseology or terminology employed herein is for the purpose of description and not of limitation. Accordingly, the invention embraces all such alternatives, modifications, equivalents and variations as fall within the spirit and scope of the appended claims.

What is claimed is:

1. A method for retrieving a record comprising:
sending a request to an in-proximity wireless communication device, the request including at least a portion of a universal identity metatag (UIM); and
receiving a record from the in-proximity wireless communication device identified by the portion of the UIM.

2. The method of claim 1 wherein sending and receiving are performed by a mobile communication device, and the method further comprises the mobile communication device discovering the in-proximity wireless communication device, wherein the in-proximity wireless communication device matches the portion of the UIM with records accessible through the in-proximity wireless communication device to identify the record for transmission to the mobile communication device.

3. The method of claim 2 wherein in response to discovering, the method includes establishing parameters for communicating over a wireless link with the wireless communication device, wherein the discovering includes an ad-hoc discovery process.

4. The method of claim 1 wherein the in-proximity wireless communication device is a personal computer of a user of a mobile communication device, the personal computer having wireless communications capability.

5. The method of claim 4 further comprising:
identifying an upcoming meeting scheduled for the user by querying a scheduling application operating on the mobile communication device; and
determining the at least portion of the UIM from the scheduling application, the at least portion of the UIM being related to the upcoming meeting or appointment,
wherein receiving, the record is received from the user's personal computer, the record being for use by the user during the upcoming meeting.

6. The method of claim 5 wherein the record is received over a wireless link and the method further comprises discovering the in-proximity wireless communication device to establish parameters for communicating over the wireless link with the wireless communication device.

7. The method of claim 1 wherein sending and receiving are performed by a mobile communication device having functionality of a wireless phone, the method further comprising:
identifying an incoming caller;
generating the at least portion of the UIM from an identity of the caller; and
presenting the record to a user of the mobile communication device.

8. The method of claim 7 wherein receiving comprises retrieving the record from memory of the mobile communication device.

9. The method of claim 7 further comprising receiving the record over a wireless link and the method further comprises discovering the in-proximity wireless communication device to establish parameters for communicating over the wireless link with the wireless communication device.

10. The method of claim 1 wherein sending the request and receiving the record are performed by a first mobile communication device, and wherein the in-proximity wireless communication device is a second mobile communication device, the second mobile communication device authenticating the first mobile communication device prior to sending the record to the first communication device.

11. The method of providing a record tagged with a universal identity metatag (UIM) comprising:
receiving a request from an in-proximity mobile communication device for a record, the request including at least a portion of a UIM;
identifying the record based on the UIM; and
transmitting the record to the in-proximity mobile communication device.

12. The method of claim 11 wherein the request includes an identity of in-proximity mobile communication device sending the request, the method further comprising:
authenticating the in-proximity mobile communication device as having permission to receive the record; and
performing the transmitting when the in-proximity mobile communication device is authenticated.

13. The method of claim 12 wherein the authenticating comprises prompting a user to select whether to send the record to the in-proximity mobile communication device.

14. The method of claim 12 further comprising checking with a policy manager and automatically transmitting the record to the in-proximity mobile communication device.

15. The method of claim 12 wherein the record is transmitted over a wireless link and the method further comprises discovering the in-proximity mobile communication device to establish parameters for communicating over the wireless link with the in-proximity mobile communication device.

16. A method for generating a universal identity metatag (UIM) comprising:
extracting source information from a record;
generating the UIM from the source information; and
embedding the UIM in the record.

17. The method of claim 16 further comprising generating the record by converting an audio conversation of the meeting to text, and
wherein extracting includes determining the source information, the source information including at least one of a meeting location, meeting time or topic as part of the source information.

18. The method of claim 17 wherein the extracting, generating and embedding is performed by a mobile communication device, and the method further comprising discovering in-proximity wireless communication devices at the meeting through an ad-hoc discovery process, and wherein the generating further comprises including an identity of the discovered in-proximity wireless communication devices in the UIM.

19. The method of claim 18 wherein extracting comprises querying a calendar application operating on the mobile communication device to determine at least some of the source information.

20. The method of claim 19 wherein extracting source information, generating the UIM and embedding the UIM are performed automatically without input from a user of the mobile communication device.

21. The method of claim 20 further comprising determining parameters for communicating over a wireless link with at least one of the in-proximity wireless communication devices at the meeting during the discovery.

22. The method of claim 21 comprising transmitting the record to the at least one of the in-proximity wireless communication devices at the meeting over the wireless communication link.

23. The method of claim 21 further comprising receiving information pertinent to the meeting from the at least one of the in-proximity wireless communication devices at the meeting.

24. A wireless communication device comprising:
a communications interface to discover an in-proximity wireless communication device (WCD) and establish a communication link therewith; and
a source extractor to extract information related to a record stored within the wireless communication device for use in generating a universal identity metatag (UIM).

25. The device of claim 24 further comprising a UIM generator to generate a UIM to associate with the record.

26. The device of claim 24 wherein the communication interface sends a request to the in-proximity wireless communication device, the request including at least a portion of the UIM, and receives the record from the in-proximity WCD identified by the portion of the UIM.

27. The device of claim 24 further comprising an identifier to identify an upcoming event scheduled for a user by querying a scheduling application operating on the WCD, and to determine at least portion of the UIM from the scheduling application, the at least portion of the UIM being related to the upcoming event.

28. The device of claim 26 wherein the record is received over a wireless link having parameters discovered by the communications interface during a discovery process.

29. The device of claim 24 wherein the communications interface includes at least one of a Bluetooth transceiver to provide digital communications in accordance with a Bluetooth protocol, a transceiver to provide digital communications in accordance an IEEE 802.11 protocol, an infrared transceiver to support an infrared serial data link and a home-RF transceiver to provide a digital communication link in accordance with a Home-RF protocol.
